(19) United States
(12) Patent Application Publication
(10) Pub. No.: US 2002/0195397 A1
(43) Pub. Date: Dec. 26, 2002

(54) Method for treating dye wastewater

(76) Inventors: Alfredo J. Teran, Cape Canaveral, FL (US); Nidal A. Samad, Merritt Island, FL (US)

Correspondence Address: SMITH & HOPEN PA, 15950 BAY VISTA DRIVE, SUITE 220, CLEARWATER, FL, 33760

(21) Appl. No.: 09/681,907

(22) Filed: Jun. 22, 2001

(51) Int. Cl. C02F 1/24; C02F 1/78

(52) U.S. Cl. 210/703; 210/721; 210/760

(57) ABSTRACT

A method for treating wastewater includes the steps of collecting wastewater in a tank and transfering the wastewater between the tank and an ozone system in a batch process or as a continuously transfering process. The oxidation of the wastewater is monitored and the wastewater is either re-used or discharged when the oxidation amount has dropped to a predetermined level. In a second embodiment, the wastewater is pre-treated by aeration. This causes contaminates to float on the surface of the wastewater and the contaminates are removed by skimming or decanting. The pre-treatment substantially reduces the power requirements of the ozone system.

### BACKGROUND OF INVENTION

Field of the Invention

This invention relates, generally, to methods for treating wastewater. More particularly, it relates to a wastewater treatment that harnesses the oxidizing power of ozone to remove contaminates.

Description of the Prior Art

Locating surface flaws or cracks of metal parts can be accomplished using penetrant inspection methods. The penetrant inspection methods are well known in various industries, especially the auto-maker industry. The penetrant contains a fluorescent dye that can penetrate the openings of surface cracks or flaws in the metal part. The penetrant is applied to the entire surface area of the metal part. The excess penetrant composition is removed from the part using rinse water so that penetrant will only be embedded in the surface flaws and cracks. The part is then exposed to appropriate lighting to reveal any surface flaws and cracks that may exist. If a flaw or crack is revealed by the penetrant, the part has failed the inspection.

Volatile solvents such as methyl ethyl ketone, kerosene or other highly volatile solvents are used in the fluorescent penetrant composition. The rinse water used to remove the excess penetrant is considered a hazardous wastewater. The rinse wastewater is required to be treated to meet environmental standards before discharging. A specialized environmental company may be utilized to properly treat and dispose of the hazardous wastewater. The cost associated with having an outside company remove and treat the hazardous wastewater can be expensive. An alternative to having an outside company remove the hazardous wastewater is to use an on-site wastewater treatment system. However, on-site wastewater treatment systems that are commercially available and capable of treating the penetrate-laden wastewater can be inefficient and expensive to operate and maintain. Additionally, if the on-site wastewater treatment system breaks down, this may prevent further penetrate inspections from continuing until the on-site wastewater treatment system is brought back on-line.

Currently, three major types of available systems for treating the hazardous wastewater are available. The first type of treatment system consists of simply using evaporation to remove the water from the wastewater leaving a thick sludge residue. The hazardous sludge must be treated and properly disposed. Evaporators use high levels of energy to remove the water and can be inefficient.

The second type of treatment system currently available consists of using filtration to remove the hazardous materials from the wastewater. A series of filters are used which have to be replaced periodically at high cost. The used filters contain hazardous materials and must be treated and properly disposed. The commercially available filters cannot meet the required environmental standards for discharge.

The third type of treatment system, which is considered to be state-of-the-art technology, consists of using nanofiltration technology. Although, this technology is successful in producing acceptable treated water, nanofilters can be unreliable in operation. Additionally, this treatment technology requires replacing the nanofiltration cartridges often, which can make this technology cost prohibitive.

One common problem to all commercially available treatment systems is the fact that the systems can only be designed to handle certain flow rates and levels of waste concentration. Thus, if the flow rate or concentration fluctuates beyond designated thresholds, the efficacy of the treatment system will be minimal.

Continuing efforts are being made to reduce the environmental impacts associated with penetrant inspection methods. By way of example, U.S. Pat. No. 3,915,886, issued to Molina discloses a readily water washable dye penetrant composition that avoids the use of conventional volatile solvents. However, the penetrant without the volatile solvents does not have the ability to remain in the surface flaws and defects as well as a penetrant with solvents and may become dislodged during rinsing. U.S. Pat. No. 3,958,940 to Conway discloses a penetrant that can be removed from the surface of a test piece with an aqueous soap solution.

However, in view of the prior art considered as a whole at the time the present invention was made, it was not obvious to those of ordinary skill in the pertinent art how an improved wastewater treatment method could be provided.

### SUMMARY OF INVENTION

The longstanding but heretofore unfulfilled need for an improved method for treating wastewater is now met by a new, useful, and nonobvious method. In a first embodiment, the novel method for treating wastewater includes the steps of providing an ozone system, collecting wastewater in a tank means, transferring the wastewater from the tank means to the ozone system, oxidizing the wastewater at the ozone system, transferring the oxidized wastewater to the tank means, monitoring the amount of oxidation of the wastewater, and repeating the process either as a batch process or as a continuous process until the amount of oxidation declines to a predetermined level.

When the oxidation has reached a predetermined level, the wastewater may be re-used as rinse water or discharged for general re-use with post-filtration.

When the wastewater is discharged, the novel method further includes the steps of providing a post ozonation filtration means for polishing and further reducing contaminates from the wastewater and routing the wastewater through the post ozonation filtration means.

In a second embodiment, the wastewater is pre-treated by separating contaminates therefrom before the wastewater is delivered to the ozone system. The pre-treating step preferably includes the step of aerating the wastewater so that contaminates float atop the aerated water. The contaminates are then either skimmed off the top or decanted from the top of the wastewater. The pre-treated wastewater is then routed to the ozone system and the balance of the second embodiment follows the steps of the first embodiment.

A primary object of the invention is to provide a treatment methodology of a dye, especially a fluorescent dye known as “penetrant” containing wastewater.

Still another object of this present invention to treat the said waste with ozone and oxidize the dye breaking it down to ultimately non-hazardous substance rendering the water acceptable for disposal or re-use.

Still another object of this present invention to provide an ozone system that is capable of treating the said waste efficiently by maximizing the mass transfer of ozone in the waste.

Still another object of this present invention to provide an ozone system that is capable of treating the said waste efficiently by maximizing the contact time between the ozone and the waste.

Still another object of this present invention to provide an ozone system that is capable of treating the said waste efficiently either using a batch or continuous process.

Still another object of this present invention to provide a polishing filtration system post the ozone system for further reducing the contamination rendering the quality of the treated water as good as city water.

Still another object of this present invention to pre-treat the said waste and reduce the concentration of the dye in the said waste by skimming and decanting and hence the ozone demand on the ozone treatment system.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF DRAWINGS

For a fuller understanding of the nature and objects of the invention, reference should be made to the following detailed description, taken in connection with the accompanying drawings, in which:

FIG. 1 is a diagrammatic depiction of a first prior art method for treating contaminated wastewater;

FIG. 2 is a diagrammatic depiction of a second prior art method;

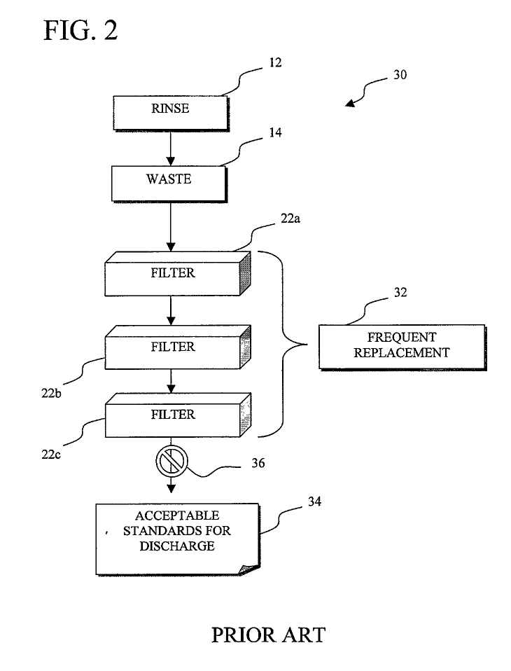

FIG. 3 is a diagrammatic depiction of a third prior art method;

FIG. 4 is a diagrammatic view of a first illustrative embodiment of the invention;

FIG. 5 is diagrammatic view of a second illustrative embodiment of the invention.

### DETAILED DESCRIPTION

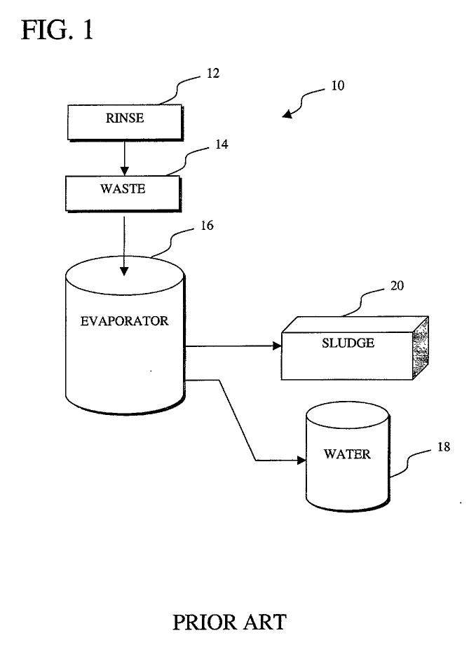

FIG. 1 depicts a prior art system 10. A metal part, not shown, is bathed in a dye and removed from the bath for rinsing at rinse system 12. The dye constitutes hazardous waste as denoted by the reference numeral 14. Wastewater 14 is pumped to evaporator tank 16. After the wastewater is evaporated, it is condensed and stored in treated water tank 18. The unevaporated sludge, which contains the contaminates, is pumped to sludge tank 20. The energy requirements of evaporator 16 are high.

In a second prior art process, denoted 30 as a whole, rinse water 12 is collected as wastewater 14 and pumped through a series of filters, denoted 22a, 22b, and 22c. These filters require frequent replacement as indicated by comment block and the resulting discharge may not meet acceptable standards for discharge 34 as indicated by negativing symbol 36.

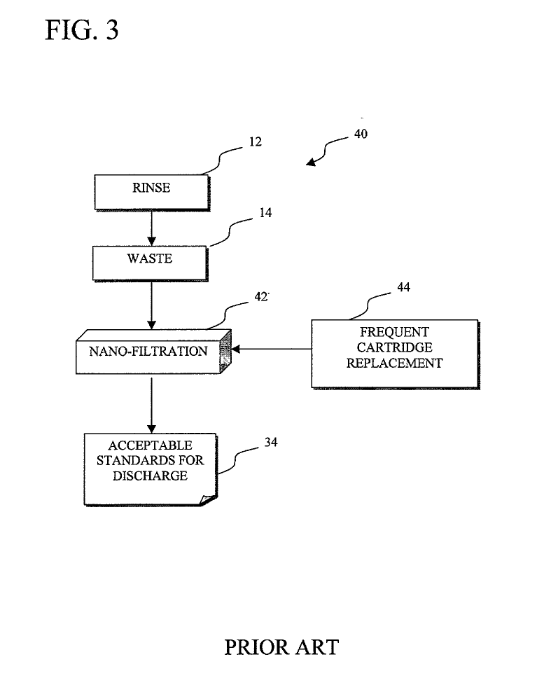

In the prior art process of FIG. 3, rinse water 12 is collected as wastewater 14 and pumped through a nano-filtration means 42. The nano-filtration cartridges require frequent replacement as indicated by comment block 44. The discharge may or may not meet accepted standards for discharge 34.

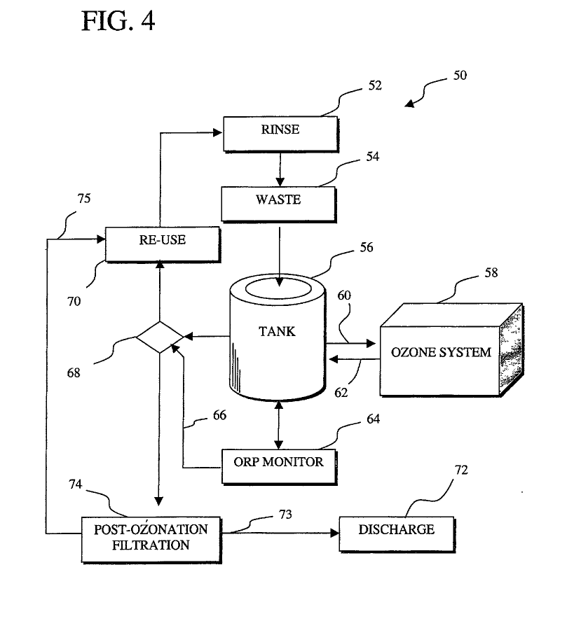

Referring now to FIG. 4, it will there be seen that the reference numeral 50 denotes an illustrative embodiment of the present invention.

Although the novel treatment disclosed herein has broad applicability to the treatment of wastewater in general, for explanatory purposes the novel treatment is described in the context of wastewater containing a particular contaminate. The particular contaminate is a one hundred per cent (100%) pure fluorescent dye known in the automotive manufacturing industry as fluorescent inspection penetrant (hereinafter referred to as “the dye”).

At the molecular level, the dye is not miscible in water and contains a large quantity of π-electrons. Oxidation and final filtration for polishing thus appear to be suitable methods for removing the dye from the wastewater.

Ozone is a strong oxidant, i.e., it is highly reactive. It is highly deficient in electrons and thus seeks out electrons. The dye has a large surplus of electrons and these electrons are collected during the ozone oxidation process. Some of the electrons of the dye are π-electrons and this further enhances the oxidation process because the force holding π-electrons to one another in a chemical bond is much weaker than the force holding σ-electrons to one another.

In a first embodiment of the novel method, depicted in FIG. 4, a metal part (not shown) is immersed in a solution (not shown) containing the dye. The metal part is then removed from the bath and rinsed at rinse system 52. The rinse water is contaminated by the dye and is thus considered hazardous waste. Accordingly, it will hereinafter be referred to as wastewater 54. Wastewater 54 is collected in tank 56 and pumped from tank 56 to ozone system 58 through a conduit means represented by directional arrow 60. The wastewater is oxidized at ozone system 58 in a manner described more described fully in U.S. Pat. Nos. 6,193,889, and in 6,090,294 which patents are hereby incorporated by reference into this disclosure. The wastewater is preferably continuously pumped back to tank 56 through conduit means represented by directional arrow 62.

However, it should be noted that the novel process need not operate continuously; a batch process is within the scope of this invention. In that configuration, the circulation between tank 56 and ozone system 58 would not be continuous.

In either a batch or continuous process, the ozone oxidation process is periodically or continuously monitored by suitable means such as an oxidation-reduction potential (ORP) device 64 or similar instrument. When ORP monitor 64 or other instrument indicates that a predetermined oxidation level has been reached, it generates a signal that follows path 66 to a decision means 68 where said treated wastewater, which no longer contains hazardous waste, is routed to a re-use station 70 for re-use as rinse water or to a post-ozonation filtration means 74 for polishing and further reduction of the contaminants. The wastewater may then be directed via conduit 73 to discharge 72 or in the alternative to said re-use station via conduit 75.

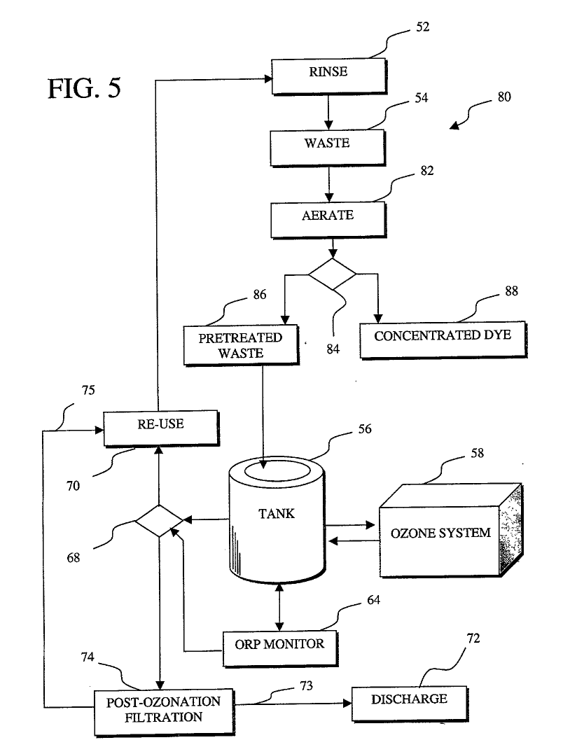

In a second embodiment, depicted in FIG. 5 and denoted as a whole by the reference numeral 80, the wastewater is pre-treated prior to being pumped to the ozone system. In a preferred form of the second embodiment, the pre-treatment is performed by aerating the waster water at aeration system 82. Such aeration causes the dye to float atop the wastewater. The system operator then decides, as indicated by decision block 84, to remove the dye by skimming or decanting. Although not all of the dye is removed by skimming or decanting, a substantial percentage thereof is removed and routed to concentrated dye station 88 and such removed concentrated dye is not treated further as a part of this method.

The wastewater remaining after the skimming or decanting process has been completed is routed to pretreated waste station 86 from which it is routed to tank 56.

As indicated by the re-use of the FIG. 4 reference numerals for the elements common to FIGS. 4 and 5, this second embodiment in all other respects is the same as the first-described embodiment. It is more advantageous than the first embodiment because the pre-treatment greatly reduces the power requirements of ozone system 58.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

now that the invention has been described,

1. A method for treating waste rinse water, comprising the steps of:
(a) providing an ozone system;
(b) collecting wastewater in a tank means;
(c) transferring said wastewater from said tank means to said ozone system;
(d) oxidizing said wastewater at said ozone system;
(e) transferring said oxidized wastewater to said tank means;
(f) monitoring the amount of oxidation of said wastewater;
repeating steps (b) through (f) until said amount of oxidation declines to a predetermined level.

2. The method of claim 1, wherein steps (c) through (e) are repeated continuously until said amount of oxidation declines to a predetermined level

3. The method of claim 1, further comprising the step of monitoring the amount of oxidation of said wastewater by monitoring the oxidation-reduction potential of said wastewater.

4. A method for treating waste rinse water, comprising the steps of:
providing an ozone system;
collecting wastewater in a tank means;
continuously transfering wastewater from said tank means to said ozone system and back to said tank means;
monitoring the amount of oxidation of said wastewater; and
discharging said wastewater when said amount of oxidation declines to a predetermined level.

5. The method of claim 4, wherein said step of discharging said wastewater further includes the steps of providing a post ozonation filtration means for polishing and further reducing contaminates from the wastewater and routing said wastewater through said post ozonation filtration means.

6. A method for treating waste rinse water, comprising the steps of:
bathing a predetermined part in a bath including contaminates;
removing said predetermined part from said bath;
providing a rinse system;
rinsing said predetermined part with water, said water becoming wastewater after having been used to perform said rinsing step;
collecting said wastewater in a wastewater tank means;
providing an ozone system;
continuously transfering wastewater from said tank means to said ozone system and back to said tank means;
monitoring the amount of oxidation of said wastewater; and
returning said wastewater to said rinse system when said amount of oxidation declines to a predetermined level.

7. A method for treating wastewater, comprising the steps of:
providing an ozone system;
pre-treating said wastewater by separating contaminates therefrom;
collecting said pre-treated wastewater in a tank means;
continuously transfering said pre-treated wastewater from said tank means to said ozone system and back to said tank means;
monitoring the amount of oxidation of said pre-treated wastewater; and
re-using said pre-treated wastewater when said amount of oxidation declines to a predetermined level.

8. A method for treating waste rinse water, comprising the steps of:
providing an ozone system;
pre-treating said wastewater by separating contaminates therefrom;
collecting said pre-treated wastewater in a tank means;
continuously transfering said pre-treated wastewater from said tank means to said ozone system and back to said tank means;
monitoring the amount of oxidation of said pre-treated wastewater; and
discharging said pre-treated wastewater when said amount of oxidation declines to a predetermined level.

9. The method of claim 8, wherein said step of discharging said pre-treated wastewater further includes the steps of providing a post ozonation filtration means for polishing and further reducing contaminates from said pre-treated wastewater and routing said pre-treated wastewater through said post ozonation filtration means.

10. The method of claim 7, wherein the step of pre-treating said wastewater includes the step of aerating said wastewater.

11. The method of claim 8, wherein the step of pre-treating said wastewater includes the step of aerating said wastewater.

12. The method of claim 7, wherein the step of aerating said wastewater includes the step of separating contaminates, floating atop said wastewater after said aerating step, from said wastewater by skimming said wastewater.

13. The method of claim 7, wherein the step of aerating said wastewater includes the step of separating contaminates, floating atop said wastewater after said aerating step, from said wastewater by skimming said wastewater.

14. The method of claim 7, wherein the step of aerating said wastewater includes the step of separating contaminates, floating atop said wastewater after said aerating step, from said wastewater by decanting said contaminates from the top of said wastewater.

15. The method of claim 8, wherein the step of aerating said wastewater includes the step of separating contaminates, floating atop said wastewater after said aerating step, from said wastewater by decanting said contaminates from the top of said wastewater.
